(19) United States
(12) Patent Application Publication
(10) Pub. No.: US 2002/0026497 A1
(43) Pub. Date: Feb. 28, 2002

(54) System, apparatus, method, and program for constructing intranet site

(75) Inventor: Masayoshi Matsuda, Tokyo (JP)

Correspondence Address: Paul J. Esatto, Jr., Scully, Scott, Murphy & Presser, 400 Garden City Plaza, Garden City, NY, 11530, US

(73) Assignee: NEC CORPORATION, TOKYO (JP)

(21) Appl. No.: 09/941,000

(22) Filed: Aug. 28, 2001

(30) Foreign Application Priority Data
Aug. 28, 2000 (JP) 257203/2000

(51) Int. Cl. G06F 15/16

(52) U.S. Cl. 709/218; 709/219

(57) ABSTRACT

A process terminal downloads a program and data necessary for producing an Intranet site having the same mechanisms and functions as those of an Internet site provided by an Internet server, from the Internet server via a network. The process terminal processes the downloaded program and data. For example, the process terminal adds original data usable within an Intranet to the downloaded data. Afterwards, the process terminal constructs the Intranet site having the same mechanisms and functions as those of the Internet site, by installing the processed program and data in an Intranet server.

### BACKGROUND OF THE INVENTION

1. Field of the Invention

The present invention relates to a system, an apparatus, a method, and a program for constructing an Intranet site.

2. Description of the Related Art

Many organizations, such as a company and the like use a private network (Intranet) to which Internet technologies are applied, to share organizational information within themselves.

Information shared on an Intranet can be searched, presented, and browsed, by use of a WWW (World Wide Web) browser or the like used to utilize services provided on the Internet.

However, to construct an Intranet site having various mechanisms and functions for searching, presenting and browsing information costs a lot of time and effort, and requires high technologies and technical senses. To keep the quality of an Intranet site at or above a predetermined level also requires the same things.

In Unexamined Japanese Patent Application KOKAI Publication No. H10-124378, a technique for downloading a plurality of documents from a WWW (World Wide Web) server, and changing the locations of target documents of linking indicated by link information contained in each downloaded document from storage locations in the WWW server to storage locations in a client is disclosed.

However, the technique disclosed in the above-indicated publication is only aimed at downloading documents from a server, and altering link information. Therefore, an Intranet site having various mechanisms and functions cannot be constructed by the above-indicated technique.

The content of the above publication is incorporated herein by reference.

### SUMMARY OF THE INVENTION

Accordingly, it is an object of the present invention to provide a system, an apparatus, a method, and a program for easily constructing an Intranet site.

To achieve the above object, the intranet site constructing system according to a first aspect of the present invention comprises:

an Internet server which provides an Internet site;

a constructing apparatus which constructs an intranet site based on the Internet site provided by the Internet server; and

an Intranet server which provides the Intranet site constructed by the constructing apparatus,

wherein the constructing apparatus includes:

a downloader which downloads the Internet site provided by the Internet server, from the Internet server via a network; and

a processor which produces the Intranet site having a same mechanism as that of the Internet site downloaded by the downloader, by processing the Internet site.

According to this invention, an Intranet site can easily be constructed.

The constructing apparatus may further include an installer which installs the Intranet site produced by the processor in the Intranet server.

The downloader may download a program and/or data necessary for producing the intranet site having the same mechanism as that of the Internet site from the Internet server.

The processor may add original data usable within an Intranet to the data downloaded by the downloader.

The Intranet site constructing apparatus according to a second aspect of the present invention comprises:

a downloader which downloads an Internet site provided by an Internet server from the Internet server via a network; and

a processor which produces an Intranet site having a same mechanism as that of the Internet site downloaded by the downloader, by processing the Internet site.

The Intranet site constructing apparatus may further comprise an installer which installs the Intranet site produced by the processor in an Intranet server.

The downloader may download a program and/or data necessary for producing the Intranet site having the same mechanism as that of the Internet site from the Internet server.

The processor may add original data usable within an Intranet to the data downloaded by the downloader.

The Intranet site constructing method according to a third aspect of the present invention comprises:

downloading an Internet site provided by an Internet server from the Internet server via a network; and

producing an Intranet site having a same mechanism as that of the downloaded Internet site by processing the Internet site.

The Intranet site constructing method may further comprise installing the Intranet site in an Intranet server.

The downloading may include downloading a program and/or data necessary for producing the Intranet site having the same mechanism as that of the Internet site from the Internet server.

The producing may include adding original data usable within an Intranet to the downloaded data.

The program according to a fourth aspect of the present invention controls a computer to function as an intranet site constructing apparatus comprising:

a downloader which downloads an Internet site provided by an Internet server from the Internet server via a network; and

a processor which produces an Intranet site having a same mechanism as that of the Internet site downloaded by the downloader, by processing the Internet site.

### BRIEF DESCRIPTION OF THE DRAWINGS

These objects and other objects and advantages of the present invention will become more apparent upon reading of the following detailed description and the accompanying drawings in which:

FIG. 1 is a block diagram showing a system for constructing an Intranet site according to an embodiment of the present invention;

FIG. 2 is a block diagram showing an Intranet constituting the constructing system shown in FIG. 1;

FIG. 3 is a block diagram showing a process terminal constituting the Intranet shown in FIG. 2; and

FIG. 4 is a flowchart explaining an operation for constructing an Intranet site performed by a CPU (Central Processing Unit) constituting the process terminal shown in FIG. 3.

### DETAILED DESCRIPTION OF THE PREFERRED EMBODIMENT

A method for constructing an Intranet site according to an embodiment of the present invention will now be explained below with reference to the accompanying drawings.

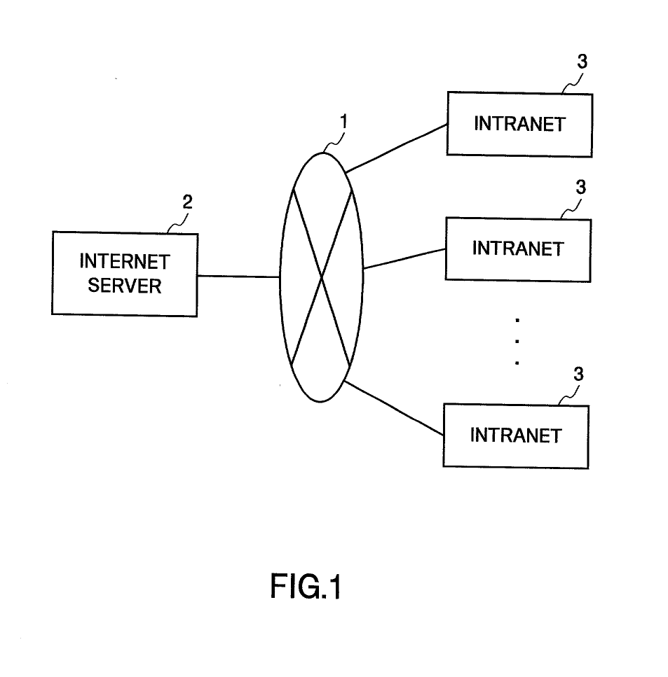

FIG. 1 is a block diagram showing a constructing system for realizing the constructing method according to this embodiment of the present invention.

As shown in FIG. 1, the constructing system comprises an Internet server 2 and a plurality of Intranets 3 connected with each other via the Internet 1.

The Internet server 2 is managed by an Internet provider. An Internet site for realizing services provided by the Internet provider is constructed in the Internet server 2.

The Internet server 2 supplies a program and data necessary for constructing an Intranet site realizing the same mechanisms and functions as those of the Internet site (such as searching, bulletin board system, and the like) to an Intranet 3 via the Internet 1 in accordance with a request from the Intranet 3.

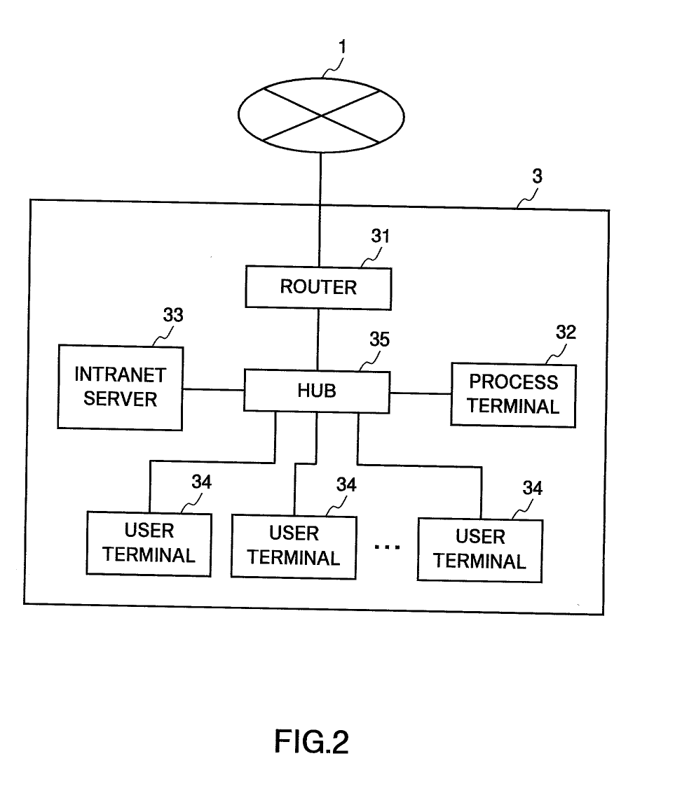

An Intranet 3 is a communications network constructed in an organization such as a company and the like, and managed by the organization. As shown in FIG. 2, the Intranet 3 comprises a router 31, a process terminal 32, an Intranet server 33, user terminals 34, and a hub 35.

The router 31 manages addresses used for communications via the Internet 1.

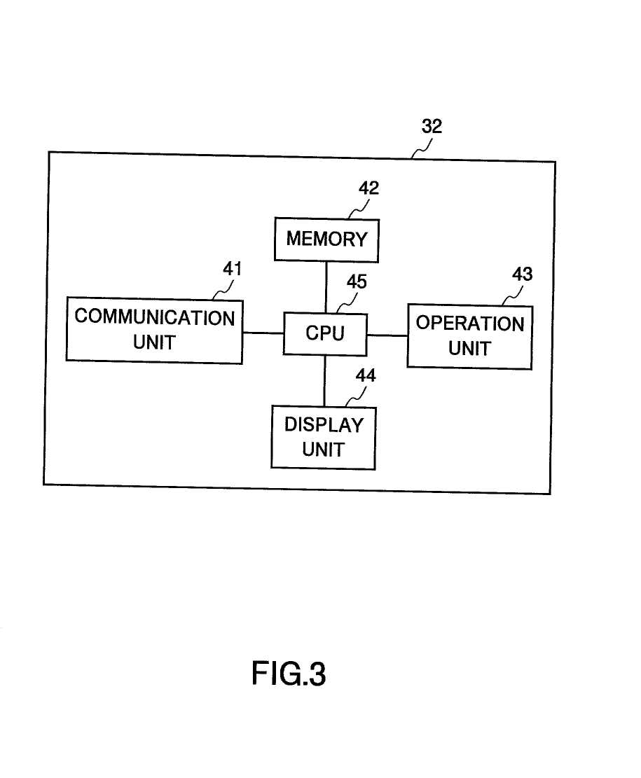

The process terminal 32 is a computer or the like, and comprises a communication unit 41, a memory 42, an operation unit 43, and display unit 44, and a CPU (Central Processing Unit) 45, as shown in FIG. 3.

The communication unit 41 is connected to the hub 35 to communicate with other terminals.

The memory 42 comprises a RAM (Random Access Memory), a ROM (Read Only Memory), and the like. The memory 42 stores a program and data for moving the process terminal 32 which are supplied previously.

The operation unit 43 comprises a keyboard, a mouse, and the like, and is operated by a user (manager) of the process terminal 32. The operation unit 43 outputs various signals for moving the process terminal 32 to the CPU 45 in accordance with an operation of the user.

The display unit 44 comprises a CRT (Cathode Ray Tube), a liquid crystal display, or the like. For example, an application for a permission to use an Internet site (described later) is made on the display unit 44.

The CPU 45 controls the move of the process terminal 32 according to the program and data stored in the memory 42. The CPU 45 downloads an Internet site (Web site) constructed in the Internet server 2 and installs the downloaded site in the Intranet server 33.

The process performed by the CPU 45 can be compared to, for example, the process of downloading, an application program via a network, and installing the downloaded program in a computer. In a case where the Internet site is a search site, the CPU 45 downloads the Internet site (a program, a script, a setting file, a database, and the like) from the Internet server 2 as if an ordinary computer downloaded an application program for searching, and installs the Internet site in the Intranet server 33. By doing so, the CPU 45 constructs an Intranet site having the same mechanisms and functions as those of the Internet site in the Intranet server 33. A more detailed explanation will be given to how to construct an Intranet site later.

The Intranet server 33 is a server set up in the Intranet 3. As described above, the Intranet site is constructed in the Intranet server 33 by the CPU 45, and provided to the user terminals 34 which constitute the Intranet 3.

The user terminal 34 comprises a computer and the like, and is operated by a user who belongs to the organization. The user terminal 34 provides the Intranet site supplied from the Intranet server 33 to the user in accordance with the user's operation.

The hub 35 connects the router 31, the process terminal 32, the Intranet server 33 and the user terminals 34 with each other.

An operation performed by the CPU 45 of the process terminal 32 in the constructing system structured as explained above, that is, a method for constructing the intranet site will be explained.

First, the manager of the Intranet server 33 applies to the Internet provider which manages the Internet server 2 for the permission to use the Internet site provided by the Internet server 2. An application for the permission to use can be made, for example, on the display unit 44 of the process terminal 32, or the display unit of the Intranet server 33.

If the permission to use is given by the Internet provider, the manager operates the operation unit 43 of the process terminal 32 following predetermined procedures, to give an instruction to construct the Intranet site.

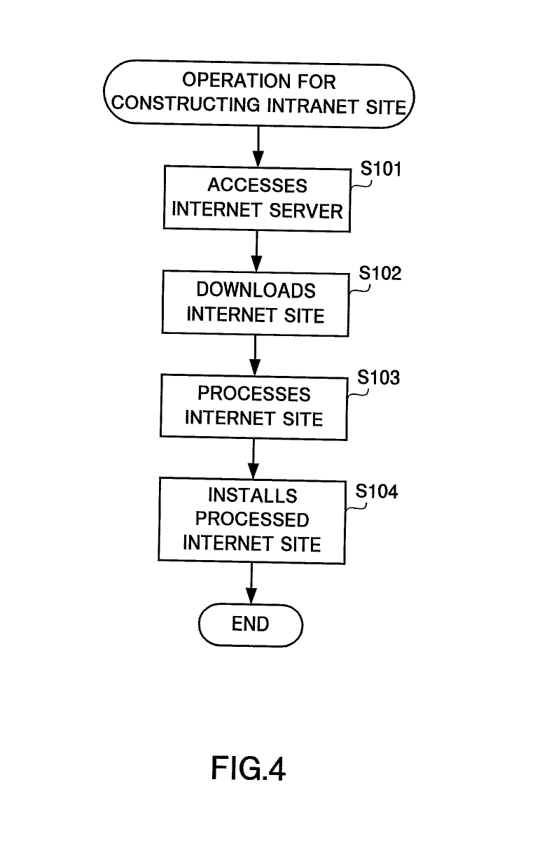

In accordance with the instruction from the manager, the CPU 45 starts the operation for constructing the Intranet site shown in FIG. 4, according to the program and data stored in the memory 42.

First, the CPU 45 accesses the Internet server 2 via the Internet 1 by controlling the communication unit 41 (step S101).

The CPU 45 downloads the Internet site (a program, a script, a setting file, a database and the like) constructed in the Internet server 2 from the Internet server 2 (step S102). At this time, the provider who manages the Internet server 2 may provide the manager of the Intranet 3 with the know-how and technical support for constructing a site having the same mechanisms and functions as those of the Internet site.

Then, the CPU 45 processes the downloaded Internet site (step S103). For example, the CPU 45 adds or changes data, and makes alterations accompanying the addition or change of data to the settings. More specifically, the CPU 45 adds original data that can be used within the organization to the database, or replaces the data stored in the database with the organization's original data. And the CPU 45 makes alterations to the setting file so that the downloaded program can move in the Intranet server 33, if necessary.

After that, the CPU 45 installs the processed Internet site in the Intranet server 33 (step S104), and completes the Intranet site constructing operation.

In the way described above, the Intranet site having the same mechanisms and functions as those of the Internet site is constructed in the Intranet server 33.

Users who belong to the organization access the Intranet server 33 by operating the user terminals 34 constituting the Intranet 3.

By operating the user terminals 34 by predetermined procedures, the users can search for, present, and browse information shared inside the organization on the Intranet site provided by the Intranet server 33.

As described above, the Intranet site has the same mechanisms and functions as those of the Internet site. Because of this, the users can use the Intranet site easily by the same operations as those performed when using the Internet site.

And with the use of the Internet site having established operational method and managing rules, the manager of the Intranet server 33 can very easily construct the Intranet site.

The organization managing the Intranet 3 may pay royalty to the provider managing the Internet server 2 when given the permission to use the Internet site.

The CPU 45 of the process terminal 32 may access the Internet server 2 at predetermined intervals, to download altered parts of the contents of the Internet site and renew the contents of the Intranet site.

By sticking in a Web page constituting the Intranet site, an original link to the Internet site, the Internet site can be easily accessed from the Intranet site. Due to this easy accessibility, brand image and publicity of the Internet provider, and access frequency to the Internet site can be improved.

The Intranet site produced by the CPU 45 of the process terminal 32 may be sold as an application program for constructing an Intranet site. At this time, a tool or the like in which the know-how to construct an Intranet site based on an Internet site is incorporated may be sold together.

There is no need to prepare a dedicated apparatus as the apparatus according to the present invention, but an ordinary computer can be used to realize the functions required in the present invention. The apparatus of the present invention can be realized by, for example, distributing a program and data for controlling a computer to execute the above-described operations by means of a recording medium (such as an FD, a CD-ROM, DVD or the like), and installing the program and data in the computer and executing those. Or, the program and data may be stored in a disk device included in a server apparatus on the Internet, and superimposed in a carrier wave to be downloaded in a computer.

Various embodiments and changes may be made thereonto without departing from the broad spirit and scope of the invention. The above-described embodiment is intended to illustrate the present invention, not to limit the scope of the present invention.

The scope of the present invention is shown by the attached claims rather than the embodiment. Various modifications made within the meaning of an equivalent of the claims of the invention and within the claims are to be regarded to be in the scope of the resent invention.

This application is based on Japanese Patent Application No. 2000-257203 filed on Aug. 28, 2000 and including specification, claims, drawings and summary. The disclosure of the above Japanese Patent Application is incorporated herein by reference in its entirety.

What is claimed is:

1. An Intranet site constructing system comprising:
an Internet server which provides an Internet site;
a constructing apparatus which constructs an Intranet site based on the Internet site provided by said Internet server; and
an Intranet server which provides the Intranet site constructed by said constructing apparatus,
wherein said constructing apparatus includes:
a downloader which downloads the Internet site provided by said Internet server, from said Internet server via a network; and
a processor which produces the Intranet site having a same mechanism as that of the Internet site downloaded by said downloader, by processing the Internet site.

2. The Intranet site constructing system according to claim 1, wherein said constructing apparatus further includes an installer which installs the Intranet site produced by said processor in said Intranet server.

3. The Intranet site constructing system according to claim 2, wherein said downloader downloads a program and/or data necessary for producing the Intranet site having the same mechanism as that of the Internet site from said Internet server.

4. The Intranet site constructing system according to claim 3, wherein said processor adds original data usable within an Intranet to the data downloaded by said downloader.

5. An Intranet site constructing apparatus comprising:
a downloader which downloads an Internet site provided by an Internet server from said Internet server via a network; and
a processor which produces an Intranet site having a same mechanism as that of the Internet site downloaded by said downloader, by processing the Internet site.

6. The Intranet site constructing apparatus according to claim 5, further comprising an installer which installs the Intranet site produced by said processor in an Intranet server.

7. The Intranet site constructing apparatus according to claim 6, wherein said downloader downloads a program and/or data necessary for producing the Intranet site having the same mechanism as that of the Internet site from said Internet server.

8. The Intranet site constructing apparatus according to claim 7, wherein said processor adds original data usable within an Intranet to the data downloaded by said downloader.

9. An Intranet site constructing method comprising:
downloading an Internet site provided by an Internet server from said Internet server via a network; and
producing an Intranet site having a same mechanism as that of the downloaded Internet site by processing the Internet site.

10. The Intranet site constructing method according to claim 9, further comprising installing the Intranet site in an Intranet server.

11. The Intranet site constructing method according to claim 10, wherein said downloading includes downloading a program and/or data necessary for producing the Intranet site having the same mechanism as that of the Internet site from said Internet server.

12. The Intranet site constructing method according to claim 11, wherein said producing includes adding original data usable within an Intranet to the downloaded data.

13. A program for controlling a computer to function as an Intranet site constructing apparatus comprising:
a downloader which downloads an Internet site provided by an Internet server from said Internet server via a network; and
a processor which produces an Intranet site having a same mechanism as that of the Internet site downloaded by said downloader, by processing the Internet site.
